(19) United States
(12) Patent Application Publication
(10) Pub. No.: US 2013/0060880 A1
(43) Pub. Date: Mar. 7, 2013

(54) Hybrid Content-Distribution System and Method

(71) Applicant: Guobiao ZHANG, Corvallis, OR (US)

(72) Inventor: Guobiao ZHANG, Corvallis, OR (US)

(73) Assignee: CHENGDU HAICUN IP TECHNOLOGY LLC, ChengDu (CN)

(21) Appl. No.: 13/597,228

(22) Filed: Aug. 28, 2012

Related U.S. Application Data
(60) Provisional application No. 61/529,925, filed on Sep. 1, 2011.

(51) Int. Cl. G06F 15/167

(52) U.S. Cl. 709/212

(57) ABSTRACT

The present invention discloses a hybrid content-distribution system. It uses two types of memory to distribute contents: re-writable memory (RWM) and three-dimensional mask-programmed read-only memory (3D-MPROM). During a publication period, new contents are transferred from a remote server to the RWM. At the end of the publication period, a user receives a 3D-MPROM, which stores a collection of the transferred contents. To make room for the contents to be released during the next publication period, the contents common to the 3D-MPROM and the RWM are deleted from the RWM afterwards.

### CROSS-REFERENCE TO RELATED APPLICATIONS

This application relates to a provisional application, “Content-Delivery System and Method Using Three-Dimensional Printed Memory”, Application Ser. No. 61/529,925, filed Sep. 1, 2011.

### BACKGROUND

1. Technical Field of the Invention

The present invention relates to the field of integrated circuit, more particularly to mask-programmed read-only memory (mask-ROM).

2. Prior Arts

With the advent of three-dimensional mask-programmed read-only memory (3D-MPROM), the storage capacity of the mask-ROM greatly improves. 3D-MPROM is primarily used for mass publication, i.e. mass distribution of mass contents. U.S. Pat. No. 5,835,396 discloses a 3D-MPROM. It is a monolithic semiconductor memory. As illustrated in FIG. 1, a typical 3D-MPROM comprises a semiconductor substrate 0 and a 3-D stack 10 stacked above. The 3-D stack 10 comprises M (M≧2) vertically stacked memory levels (e.g. 10A, 10B). Each memory level (e.g. 10A) comprises a plurality of upper address lines (e.g. 2a), lower address lines (e.g. 1a) and memory cells (e.g. 5aa). Each memory cell stores n (n≧1) bits. Memory levels (e.g. 10A, 10B) are coupled to the substrate 0 through contact vias (e.g. 1av, 1av′). The substrate circuit OX in the substrate 0 comprises a peripheral circuit for the 3-D stack 10. Hereinafter, xM×n 3D-MPROM denotes a 3D-MPROM comprising M memory levels with n bits-per-cell (bpc).

3D-MPROM is a diode-based cross-point memory. Each memory cell (e.g. 5aa) typically comprises a diode 3d. The diode can be broadly interpreted as any device whose electrical resistance at the read voltage is lower than that when the applied voltage has a magnitude smaller than or polarity opposite to that of the read voltage. The memory level 10A further comprises a data-coding layer 6A, i.e. a blocking dielectric 3b. It blocks the current flow between the upper and lower address lines. Absence or existence of a data-opening 6ca in the blocking dielectric 3b indicates the state of a memory cell. Besides the blocking dielectric 3b, the data-coding layer 6A could also comprise a resistive layer (referring to U.S. patent application Ser. No. 12/785,621) or an extra-dopant layer (referring to U.S. Pat. No. 7,821,080).

Because the prior-art mask-ROM has a limited storage capacity, when it is used for content distribution, a separate new mask-ROM card is issued for each newly released content. FIG. 2 illustrates an example. Contents C₁ (e.g. movie 1), C₂ (e.g. movie 2), . . . are released at time t₁, t₂, . . . , respectively. A separate mask-ROM card is issued for each new content: at time t₁, a first mask-ROM card m₁, which stores the content C₁, is delivered to a user; at time t₂, a second mask-ROM card m₂, which stores the content C₂, is delivered to the user; . . . . As more and more contents are released, this content-distribution method becomes cumbersome, because the user needs to manage hundreds, even thousands of mask-ROM cards.

### OBJECTS AND ADVANTAGES

It is a principle object of the present invention to provide a content-distribution system that makes memory-card management easier for a user.

It is a further object of the present invention to provide a content-distribution method that offers a user timely access to the new contents.

It is a further object of the present invention to provide a content-distribution method that keeps the cost of the content storage low.

In accordance with these and other objects of the present invention, hybrid content-distribution system and method are disclosed.

### SUMMARY OF THE INVENTION

The present invention discloses a hybrid content-distribution system. It comprises a playback device (e.g. cellular phone, internet TV, or computer) and uses two types of memory to distribute contents: re-writable memory (RWM) and 3D-MPROM. The RWM is part of the playback device, while the 3D-MPROMs are periodically delivered to a user.

Hybrid content-distribution takes advantage of the fact that the 3D-MPROM is much less expensive than the RWM and stores the past contents in the 3D-MPROM. It also takes advantage of the fact that the RWM is re-writable and stores the new contents in the RWM. During a publication period, new contents, once released, are transferred from a remote server to the playback device and saved into the RWM. At the end of the publication period, a user receives a 3D-MPROM card which stores a collection of the transferred contents. To make room for the contents to be released during the next publication period, the contents common to the 3D-MPROM and the RWM are deleted from the RWM. Hybrid content-distribution offers the user timely access to the new contents while keeping the overall storage cost low.

### BRIEF DESCRIPTION OF THE DRAWINGS

FIG. 1 is a cross-sectional view of a 3D-MPROM;

FIG. 2 discloses a content-distribution method from prior arts;

FIG. 3 is a block diagram of a preferred hybrid content-distribution system and its communication with a remote server;

FIGS. 4A-4B illustrate two preferred playback devices;

FIG. 5 is a flow chart for a preferred hybrid content-distribution method;

FIG. 6 illustrates the amount of the occupied space in the RWM at different time points;

FIGS. 7A-7B are cross-sectional views of a preferred 3D-MPROM cartridge at different time points T₁, T₂.

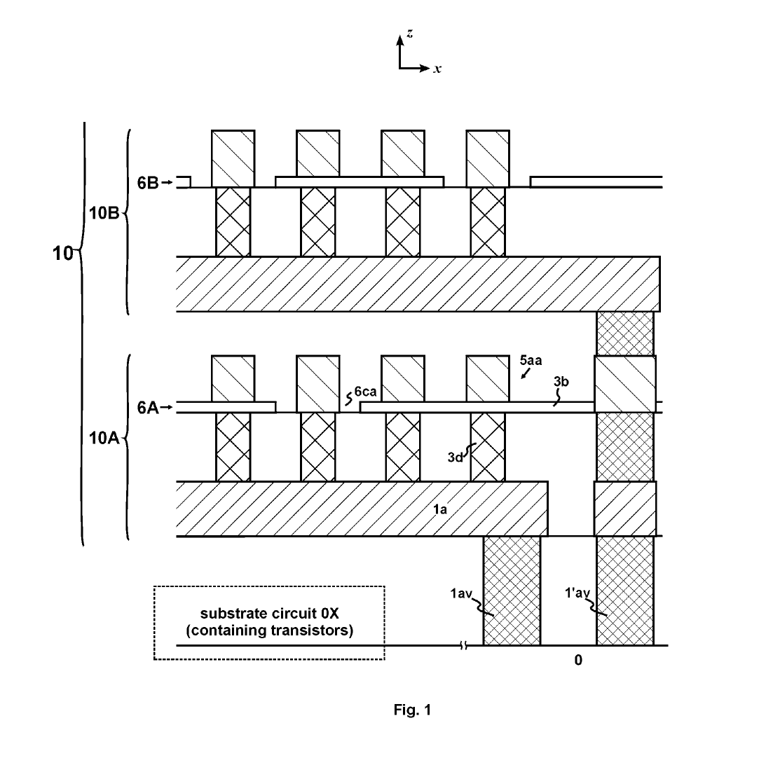

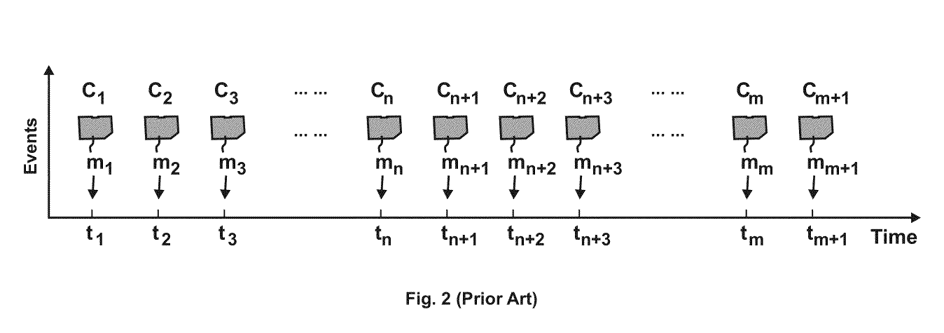

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention uses 3D-MPROM as an example to explain the concept of hybrid content-distribution. The preferred embodiments disclosed herein can be extended to any large-capacity mask-ROM. A large-capacity mask-ROM has a storage capacity on the order of GB, even on the order of TB. In the present invention, the primary data-recording means for a mask-ROM includes photo-lithography and imprint-lithography. The “mask” in the mask-ROM includes data-mask used in photo-lithography, as well as nano-imprint mold or nano-imprint template used in imprint-lithography.

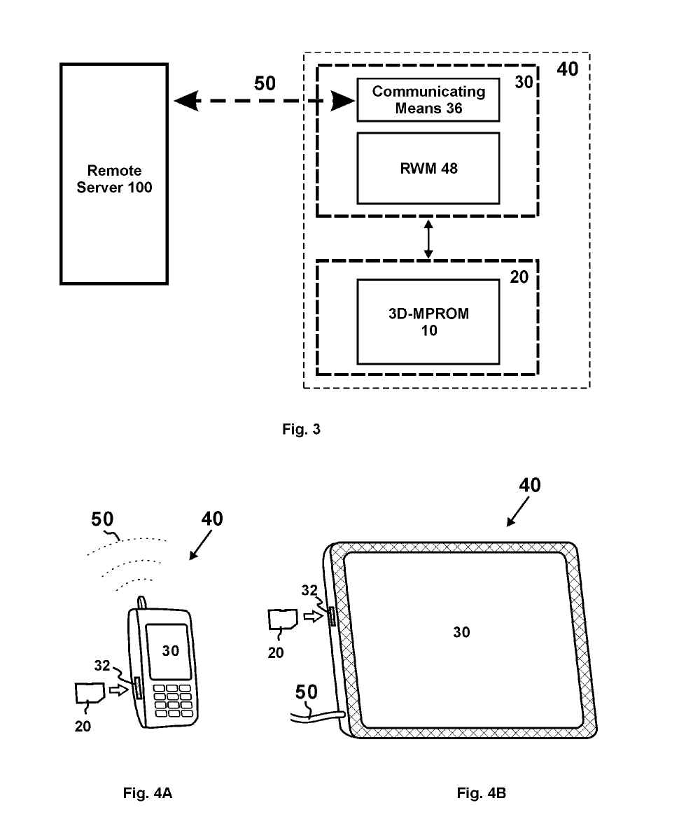

Referring now to FIG. 3, a preferred hybrid content-distribution system 40 and its communication channel 50 with a remote server 100 are disclosed. It comprises a memory card 20 and a playback device 30. The memory card 20 could comprise a memory package or a memory module. It contains at least one 3D-MPROM die, more generally, at least one large-capacity mask-ROM die. The memory card 20 stores contents such as movies, video games, maps, music library, book library, and/or softwares.

The playback device 30, more generally, a consumer processing apparatus, can read and process data from the memory card 20, e.g. playing a movie or video game, reading a map, listening to music, reading books, or running software. The playback device 30 comprises a communicating means 36 and a re-writable memory (RWM) 48. The communicating means 36 communicates with a remote server 100 through a communication channel 50. The remote server 100 stores a mass-content library. The communication channel 50 includes internet, WiFi and cellular (e.g. 3G, 4G) signals. The RWM 48 is a non-volatile re-writable memory, e.g. a flash memory.

FIG. 4A illustrates a preferred playback device 30—a cellular phone. It communicates with the remote server 100 via cellular signals 50. The cellular phone 30 further comprises a slot 32 for holding the memory card 20, which can be inserted into or removed from the cellular phone 30. FIG. 4B illustrates another preferred playback device 30—an internet TV (or, a computer). It communicates with the remote server 100 via internet signals (including wired and wireless internet signals) 50. The internet TV (or, computer) 30 further comprises a slot 32 for holding the memory card 20, which can be inserted into or removed from the internet TV (or, computer) 30.

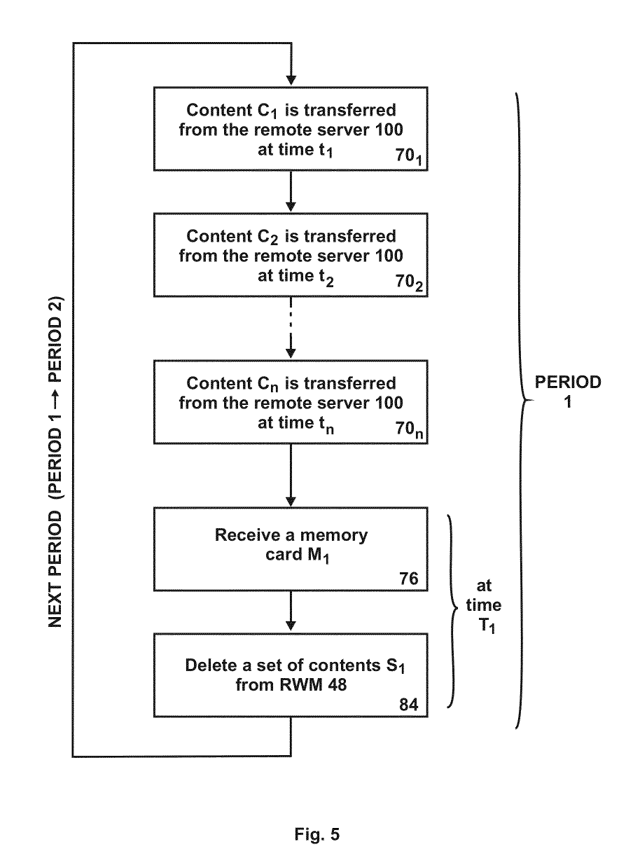

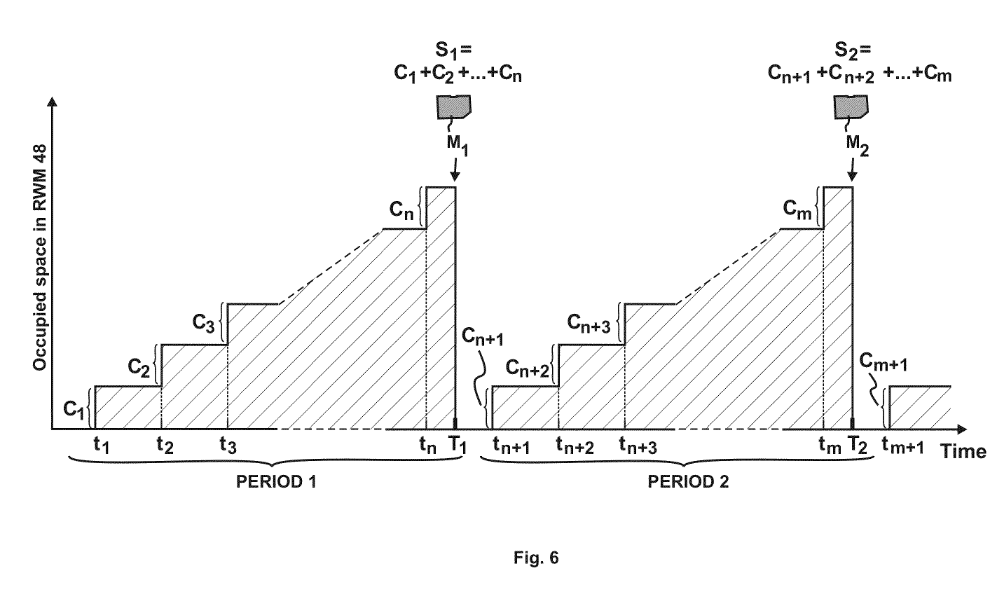

The present invention discloses a hybrid content-distribution method. It takes advantage of the fact that the 3D-MPROM is much less expensive than the RWM and stores the past contents in the 3D-MPROM. It also takes advantage of the fact that the RWM is re-writable and stores the new contents in the RWM. FIG. 5 discloses a preferred hybrid content-distribution method; and FIG. 6 illustrates the amount of the occupied space in the RWM 48 at different time points.

The preferred hybrid content-distribution method includes a number of publication periods (e.g. PERIOD 1 and PERIOD 2). Each publication period comprises similar steps. During PEORID 1 (e.g. during the first two months), new contents (i.e. the contents released during the current publication period), once released, are transferred from the remote server 100 to the playback device 30. For example, content C₁ (e.g. movie 1) is transferred at time t₁ (step 701); content C₂ (e.g. movie 2) is transferred at time t₂ (step 702); . . . ; content Cₙ (e.g. movie n) is transferred at time tₙ (step 70n). Here, new contents are either downloaded by the playback device 30 or pushed in by the remote server 100. The transferred contents are stored in the RWM 48. This is reflected by the staircase RWM curve between t₁ and T₁ of FIG. 6. During PERIOD 1, the contents C₁, C₂, . . . Cₙ are accessed from the RWM 48.

At the end of PERIOD 1, a first set of contents S₁ (=C₁+C₂+ . . . +Cₙ) is accumulated in the RWM 48. At time T₁, a user receives a first memory card M₁ (step 76), which permanently stores the first set of contents S₁. Afterwards, the first set of contents S₁ is deleted from the RWM 48 (step 84). This is reflected by the steep drop of the RWM curve at T₁ in FIG. 6. Because the RWM 48 is emptied, PERIOD 2 can now start. After PERIOD 1, the contents C₁, C₂, . . . Cₙ can be accessed from the memory card M₁.

During PERIOD 2 (e.g. during the next two months), similar steps (steps 70₁-84) are performed. Contents Cₙ₊₁, Cₙ₊₂, . . . Cₘ are transferred at time tₙ₊₁, tₙ₊₂, . . . tₘ, respectively. During this period, the contents Cₙ₊₁, Cₙ₊₂, . . . Cₘ are accessed from the RWM 48. At the end of PERIOD 2, a second set of contents S₂ (=C_{n +1}+Cₙ₊₂+ . . . +Cₘ) is accumulated in the RWM 48. At time T₂, the user receives a second memory card M₂, which permanently stores the second set of contents S₂. Then the second set of contents S₂ is deleted from the RWM 48. After PERIOD 2, the contents Cₙ₊₁, Cₙ₊₂, . . . Cₘ are accessed from the second memory card M₂.

Because the playback device 30 can communicate with the remote server 100 in a timely manner, the preferred hybrid content-distribution method offers the user timely access to the new contents. Moreover, because the past contents (i.e. contents released during the previous publication periods) are stored in the memory cards (e.g. M₁, M₂, . . . ) and only the new contents need to be stored in the RWM 48, the playback device 30 only needs a limited amount of the RWM 48. Since the 3D-MPROM is much less expensive than the RWM, the overall storage cost for this hybrid content-distribution method is much lower than prior arts where all contents are stored in the RWM.

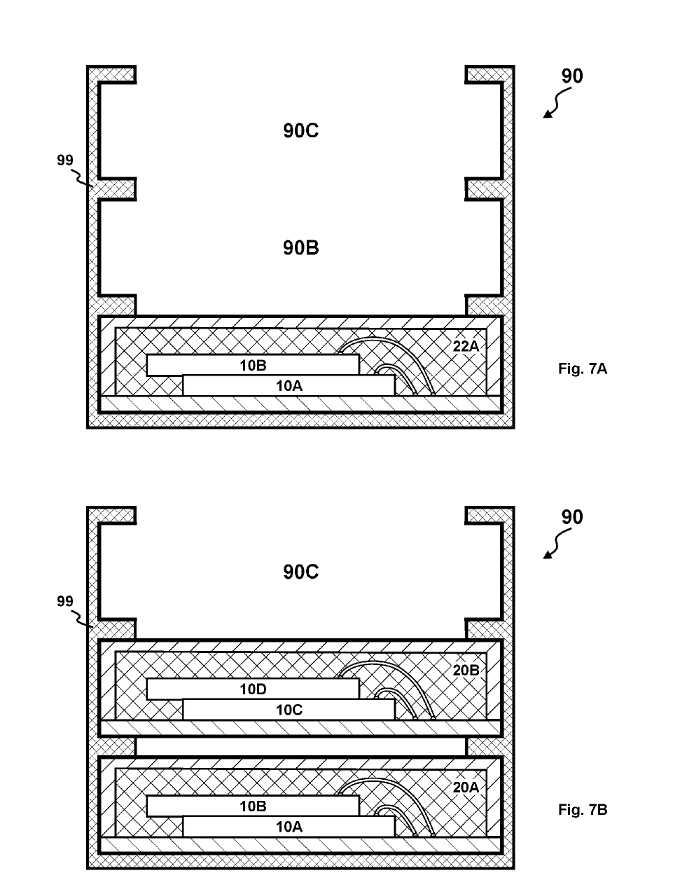

The present invention further discloses a preferred 3D-MPROM cartridge 90 that can accommodate hybrid content-distribution. FIGS. 7A-7B illustrate its configurations at different time points T₁, T₂. The 3D-MPROM cartridge 90 comprises a cartridge frame 99, which comprises a plurality of slots (e.g. 90B, 90C) for holding the memory cards. At T₁, a memory card 20A, which comprises two vertically stacked 3D-MPROM dice 10A, 10B, is released. It is inserted into the bottom slot of the memory cartridge 90. At this time, the slots 90B, 90C are empty. At T₂, the memory card 20B, which comprises two vertically stacked 3D-MPROM dice 10C, 10D, is released. It is then inserted into the slot 90B. At this time, the slot 90C is empty. The cartridge frame 99 can provide electrical connections between the memory cards 20A and 20B (not shown in this figure). Preferably, the playback device 30 can directly read data from the 3D-MPROM cartridge 90. Apparently, the preferred memory cartridge 90 can have more than three slots. For example, it may comprise six slots. Assuming a new memory card is released every two month, a single memory cartridge can hold all memory cards released in a year. The memory cartridge 90 makes the memory-card management much easier.

While illustrative embodiments have been shown and described, it would be apparent to those skilled in the art that may more modifications than that have been mentioned above are possible without departing from the inventive concepts set forth therein. Besides 3D-MPROM, the field-repair system and method disclosed herein can be extended to other mask-ROMs. The invention, therefore, is not to be limited except in the spirit of the appended claims.

What is claimed is:

1. A hybrid content-distribution system, comprising:
a consumer processing apparatus comprising a communicating means and a re-writable memory (RWM), wherein said consumer processing apparatus transfers contents from a remote server to said RWM with said communicating means during a time period;
a three-dimensional mask-programmed read-only memory (3D-MPROM) comprising a plurality of vertically stacked memory levels, wherein said 3D-MPROM permanently stores a set of the contents transferred during said time period, and the contents common to said 3D-MPROM and said RWM are deleted from said RWM after a user receives said 3D-MPROM.

2. The hybrid content-distribution system according to claim 1, wherein said consumer processing apparatus is a cellular phone, an internet TV, or a computer.

3. The hybrid content-distribution system according to claim 1, wherein said communicating means include internet, WiFi and cellular communication means.

4. The hybrid content-distribution system according to claim 1, wherein said RWM is a flash memory.

5. The hybrid content-distribution system according to claim 1, wherein said 3D-MPROM is located in a memory card.

6. The hybrid content-distribution system according to claim 5, wherein said consumer processing apparatus comprises a slot for holding said memory card.

7. The hybrid content-distribution system according to claim 5, wherein said memory card is located in a memory cartridge comprising a plurality of slots.

8. A hybrid content-distribution method, comprising the steps of:
1) transferring contents from a remote server to a re-writable memory (RWM) with a communicating means during a time period;
2) receiving a three-dimensional mask-programmed read-only memory (3D-MPROM) storing a set of the transferred contents at the end of said time period;
3) deleting the contents common to said 3D-MPROM and said RWM from said RWM;
wherein said RWM and said communicating means are located in a consumer processing apparatus.

9. The hybrid content-distribution method according to claim 8, wherein said consumer processing apparatus is a cellular phone, an internet TV, or a computer.

10. The hybrid content-distribution method according to claim 8, wherein said communicating means include internet, WiFi and cellular communication means.

11. The hybrid content-distribution method according to claim 8, wherein said RWM is a flash memory.

12. The hybrid content-distribution method according to claim 8, wherein said 3D-MPROM is located in a memory card.

13. The hybrid content-distribution method according to claim 12, wherein said consumer computing device comprises a slot for holding said memory card.

14. The hybrid content-distribution method according to claim 12, wherein said memory card is located in a memory cartridge comprising a plurality of slots.

15. A hybrid content-distribution method, comprising the steps of:
1) transferring contents from a remote server to a re-writable memory (RWM) with a communicating means during a time period;
2) receiving a mask-programmed read-only memory (mask-ROM) storing a set of the transferred contents at the end of said time period;
3) deleting the contents common to said mask-ROM and said RWM from said RWM;
wherein said RWM and said communicating means are located in a consumer processing apparatus.

16. The hybrid content-distribution method according to claim 15, wherein said mask-ROM is a three-dimensional mask-programmed read-only memory (3D-MPROM).

17. The hybrid content-distribution method according to claim 15, wherein said consumer processing apparatus is a cellular phone, an internet TV, or a computer.

18. The hybrid content-distribution method according to claim 15, wherein said communicating means include internet, WiFi and cellular communication means.

19. The hybrid content-distribution method according to claim 15, wherein said RWM is a flash memory.

20. The hybrid content-distribution method according to claim 15, wherein said 3D-MPROM is located in a memory card.
